(19) United States
(12) Patent Application Publication
(10) Pub. No.: US 2021/0043886 A1
(43) Pub. Date: Feb. 11, 2021

(54) SECONDARY BATTERY

(71) Applicant: MURATA MANUFACTURING CO., LTD., Kyoto (JP)

(72) Inventors: Kenji OSHIMA, Kyoto (JP); Koji HATTORI, Kyoto (JP); Shuichi NAGAOKA, Kyoto (JP)

(21) Appl. No.: 17/071,621

(22) Filed: Oct. 15, 2020

Related U.S. Application Data
(63) Continuation of application No. PCT/JP2019/015337, filed on Apr. 8, 2019.

(30) Foreign Application Priority Data
Apr. 19, 2018 (JP) 2018-080805

(51) Int. Cl. H01M 2/02; H01M 10/0525; H01M 2/08

(52) U.S. Cl. CPC H01M 2/0287; H01M 10/0525; H01M 2002/0297; H01M 2/08; H01M 2/0285

(57) ABSTRACT

Provided is a secondary battery in which a sealing edge of a battery exterior body is formed by a combination of a first exterior body portion and a second exterior body portion of an exterior body that accommodate an electrode assembly. The second exterior body portion is folded so as to sandwich the first exterior body portion at the sealing edge, and a folded bonding portion is having a folded form in a sectional view of the sealing edge is provided in a metal interlayer region between a metal layer of the first exterior body portion and a folded metal layer of the second exterior body portion.

### CROSS REFERENCE TO RELATED APPLICATIONS

The present application is a continuation of PCT patent application no. PCT/JP2019/015337, filed on Apr. 8, 2019, which claims priority to Japanese patent application no. JP2018-080805 filed on Apr. 19, 2018, the entire contents of which are being incorporated herein by reference.

### BACKGROUND

The present technology generally relates to a secondary battery. In particular, the present technology relates to a secondary battery including an electrode assembly formed of an electrode configuration layer including a positive electrode, a negative electrode, and a separator.

Secondary batteries are so-called rechargeable batteries, and thus, can be repeatedly charged and discharged, and are used for various purposes. For example, secondary batteries are used in mobile devices such as a mobile phone, a smartphone, and a laptop computer.

In various battery applications including mobile devices, the secondary battery is used in the state of being housed in a housing. That is, the secondary battery is arranged so as to partially occupy the inside of the housing of a device to be used.

### SUMMARY

Conventional secondary batteries have problems that need to be overcome and has found the necessity of taking measures for such problems.

A secondary battery includes an electrode assembly in which electrode configuration layers each including a positive electrode, a negative electrode, and a separator therebetween are stacked, and an exterior body that encloses the electrode assembly. The exterior body is formed of a first exterior body portion located on one side and a second exterior body portion located on the other side with the electrode assembly interposed therebetween, and the respective peripheral edges of the exterior body portions are aligned with each other to form a sealing edge.

Here, in the case where each of the first exterior body portion and the second exterior body portion of the exterior body has a laminate structure including a laminated layer of a metal layer and an adhesive layer, a ratio of the sealing edge to a cell width becomes larger only by attaching the peripheral edges to each other to perform sealing (see FIG. 11(A)). That is, an energy density decreases due to a protruding size of the sealing edge as can be understood from a form in a sectional view illustrated in FIG. 11(A). Therefore, it is conceivable to bend the attached first exterior body portion and second exterior body portion. However, there is a risk that the battery is likely to spring back only by the bending in the above state due to the influence of the thickness of these exterior body portions or the like (FIG. 11(B)). That is, there is a risk that bending back occurs.

Therefore, as illustrated in FIG. 11(C), it is conceivable to form one exterior body portion (second exterior body portion) to be relatively longer than the other exterior body portion (first exterior body portion) and decrease the width of the sealing edge of the battery by partially removing the adhesive layer to reduce the thickness and bending the one exterior body. In such a case, the bending back hardly occurs, but it is difficult to say that a sealing force is sufficient. This is because a condition is formed where moisture in the surrounding environment is more likely to enter the inside of the exterior body. This is because the distance at which the moisture passes from the outside to the inside of the exterior body through the adhesive layer becomes shorter as the adhesive layer of the exterior body exhibits moisture permeability to some extent. In this manner, under the condition where the moisture easily enters into the battery through the adhesive layer of the exterior body, there is a risk that the battery performance deteriorates due to side reactions or the like occurring due to the moisture that has entered the exterior body, which is desirable for the secondary battery.

The present technology has been made in view of such problems. That is, one object of the present technology is to provide a secondary battery that is more suitable in terms of both the energy density and prevention of entry of moisture.

The inventor of the present application has tried to solve the above-described problems by addressing the problems from a new direction, rather than addressing the problems by extension of the conventional technology. As a result, a secondary battery that achieves the above-described object has been invented.

According to an embodiment of the present technology, there is provided a secondary battery including an electrode assembly and an exterior body configured to accommodate the electrode assembly. In the secondary battery, the exterior body includes a first exterior body portion, a second exterior body portion and a sealing edge. The sealing edge is formed of a combination of the first exterior body portion and the second exterior body portion of the exterior body. The second exterior body portion is folded so as to sandwich the first exterior body portion at the sealing edge, and a folded bonding portion in a folded form (the folded bonding portion in the form of being folded in a sectional view of the sealing edge) is provided in a metal interlayer region between a metal layer of the first exterior body portion and a metal layer of the folded second exterior body portion.

The secondary battery of the present technology is more suitable in terms of both the energy density and the prevention of entry of moisture.

Specifically, since the second exterior body portion is folded so as to sandwich the first exterior body portion in the secondary battery of the present technology, a dimension of a battery width is further decreased, which is suitable in terms of the energy density.

Further, the “bonding portion in the folded form” is provided in the metal interlayer region between the “metal layer of the first exterior body portion” and the “metal layer of the folded second exterior body portion” in the secondary battery of the present technology, so that a moisture passage path corresponding to the distance from the outside of the battery to the inside of the battery through the bonding portion is formed to be longer. Accordingly, the moisture in the surrounding environment is less likely to enter the inside of the exterior body, and the secondary battery is also suitable in terms of the prevention of entry of moisture.

It should be understood that the effects described here are not necessarily limited, and may be any one of the effects described in the present disclosure or effects different therefrom.

### BRIEF DESCRIPTION OF THE FIGURES

FIG. 1A is a sectional view schematically illustrating a non-winding flat laminated type of an electrode configuration layer; FIG. B is a sectional view schematically illustrating a winding type of an electrode configuration layer according to an embodiment of the present technology.

FIG. 2 is a schematic sectional view illustrating a basic configuration of an exterior body of a secondary battery according to an embodiment of the present technology.

FIG. 3A is a schematic sectional view for explaining a moisture permeation path in the case of a “bonding portion” that does not relate to the present technology, FIG. 3B is a schematic sectional view for explaining a moisture permeation path in the case of a “folded bonding portion” that relates to the present technology according to an embodiment of the present disclosure.

FIG. 4 is a schematic sectional view illustrating an aspect of a sealing edge in which an end surface of a folded second exterior body portion is in contact with a side surface portion of the exterior body according to an embodiment of the present disclosure.

FIG. 5 is a schematic sectional view illustrating a configuration of the sealing edge of the secondary battery in a case where the folded bonding portion is formed of a combination of thermally-fusible resin layers of a first exterior body portion and the second exterior body portion according to an embodiment of the present disclosure.

FIG. 6A is a schematic sectional view illustrating formation of the sealing edge before folding; FIG. 6B is a schematic sectional view illustrating formation of the sealing edge during folding; and FIG. 6C is a schematic sectional view illustrating formation of the sealing edge after folding according to an embodiment of the present disclosure.

FIG. 7A is a schematic plan view for explaining a relatively large cell width; and FIG. 7B is a schematic plan view for explaining a relatively small cell width according to an embodiment of the present disclosure.

FIG. 8 is a graph illustrating a relationship between a cell width and a volume energy density regarding a battery having a “non-folded bonding portion” and a battery having a “folded bonding portion”, and an explanatory view thereof according to an embodiment of the present disclosure.

FIG. 9 is a schematic plan view illustrating an aspect in which sealing edges are provided at two locations according to an embodiment of the present disclosure.

FIG. 10A is a schematic sectional view illustrating an aspect in which a protective layer provided on an outer surface of the second exterior body portion; and FIG. 10B is a schematic sectional view illustrating an aspect in which a protective layer provided on an outer surface of the non-sealing edge portion of the first exterior body portion according to an embodiment of the present disclosure.

FIGS. 11A to 11C are schematic sectional views for explaining a problem in conventional technology regarding the sealing edge of the exterior body; FIG. 11A: only attaching and sealing, FIG. 11B: simple bending, FIG. 11C: sealing that has a problem in terms of entry of moisture.

### DETAILED DESCRIPTION

As described herein, the present disclosure will be described based on examples with reference to the drawings, but the present disclosure is not to be considered limited to the examples, and various numerical values and materials in the examples are considered by way of example.

A “thickness” direction described directly or indirectly in the present specification is based on a stacking direction of electrode materials forming the secondary battery. For example, in the case of a “plate-like secondary battery having a thickness” such as a flat battery, the “thickness” direction corresponds to a plate thickness direction of the secondary battery. A “sectional view” in the present specification is based on a virtual cross section of an object cut along the thickness direction of the secondary battery. Further, a “plan view” used in the present specification is based on a sketch drawing of an object viewed from above or below along the thickness direction.

Furthermore, a “vertical direction”, a “horizontal direction”, and the like used directly or indirectly in the present specification respectively correspond to the vertical direction and the horizontal direction in the drawings.

Unless otherwise specified, the same reference signs or symbols denote the same members or the same semantic contents. In one suitable aspect, it can be understood that the downward direction in the vertical direction (that is, a direction in which gravity acts) corresponds to the “downward direction” and the opposite direction corresponds to the “upward direction”.

The “secondary battery” used in the present specification refers to a battery that can be repeatedly charged and discharged. Therefore, the secondary battery according to the present technology is not overly limited to its name, and may include, for example, a power storage device or the like, as a target.

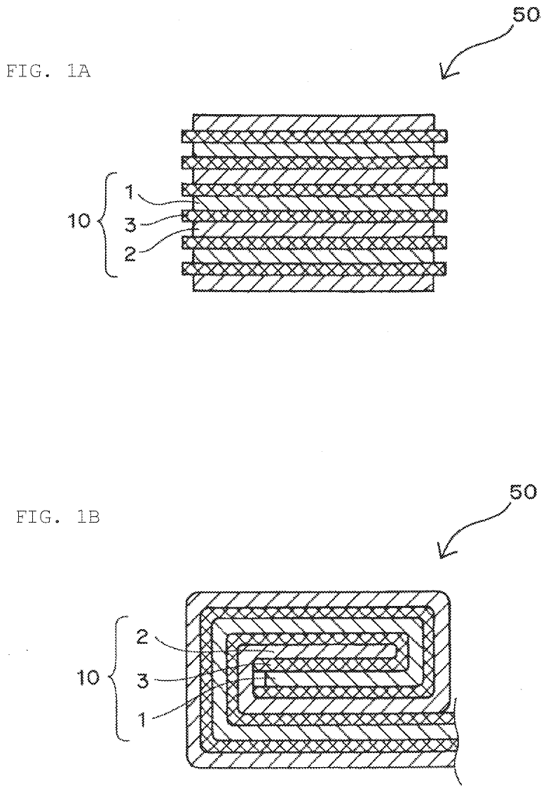

The secondary battery according to the present technology includes an electrode assembly in which electrode configuration layers each including a positive electrode, a negative electrode, and a separator are stacked. An electrode assembly 50 is illustrated in FIGS. 1(A) and 1(B). As illustrated in the drawings, a positive electrode 1 and a negative electrode 2 are stacked with the separator 3 interposed therebetween to form an electrode configuration layer 10, and at least one or more such electrode configuration layers 10 are laminated to form the electrode assembly. In the secondary battery, such an electrode assembly is enclosed in an exterior body together with an electrolyte (for example, a non-aqueous electrolyte).

The positive electrode is formed of at least a positive electrode material layer and a positive electrode current collector. In the positive electrode, the positive electrode material layer is provided on at least one surface of the positive electrode current collector, and the positive electrode material layer contains a positive electrode active material as an electrode active material. For example, each of the plurality of positive electrodes in the electrode assembly may be configured such that the positive electrode material layers are provided on both surfaces of the positive electrode current collector or the positive electrode material layer is provided only on one surface of the positive electrode current collector. From the viewpoint of further increasing the capacity of the secondary battery, the positive electrode preferably has the positive electrode material layers provided on both the surfaces of the positive electrode current collector.

The negative electrode is formed of at least a negative electrode material layer and a negative electrode current collector. In the negative electrode, the negative electrode material layer is provided on at least one surface of the negative electrode current collector, and the negative electrode material layer contains a negative electrode active material as an electrode active material. For example, each of the plurality of negative electrodes in the electrode assembly may be configured such that the negative electrode material layers are provided on both surfaces of the negative electrode current collector or the negative electrode material layer is provided only on one surface of the negative electrode current collector. From the viewpoint of further increasing the capacity of the secondary battery, the negative electrode preferably has the negative electrode material layers provided on both the surfaces of the negative electrode current collector.

The electrode active materials contained in the positive electrode and the negative electrode, that is, the positive electrode active material and the negative electrode active material, are substances directly involved in the transfer of electrons in the secondary battery, and are the main substances of the positive and negative electrodes responsible for charge and discharge, that is, battery reaction. More specifically, ions are introduced into the electrolyte due to the “positive electrode active material contained in the positive electrode material layer” and the “negative electrode active material contained in the negative electrode material layer”, and the ions move between the positive electrode and the negative electrode to transfer electrons to perform the charge and discharge. In particular, the positive electrode material layer and the negative electrode material layer are preferably layers capable of storing and releasing lithium ions. That is, it is preferable to form a non-aqueous electrolyte secondary battery in which the lithium ions move between the positive electrode and the negative electrode via the non-aqueous electrolyte to charge and discharge the battery. When the lithium ions are involved in the charge and discharge, the secondary battery according to the present technology corresponds to a so-called lithium ion battery, and the positive electrode and the negative electrode have layers capable of storing and releasing the lithium ions.

It is preferable that the positive electrode active material of the positive electrode material layer be made of, for example, a granular material, and that the positive electrode material layer contain a binder for more sufficient contact between particles and shape retention. Furthermore, the positive electrode material layer may contain a conductive auxiliary agent in order to facilitate the transfer of electrons promoting the battery reaction. Similarly, it is preferable that the negative electrode active material of the negative electrode material layer be made of, for example, a granular material and contain a binder for more sufficient contact between particles and shape retention, and the negative electrode material layer may contain a conductive auxiliary agent to facilitate the transfer of electrons promoting the battery reaction. In this manner, the positive electrode material layer and the negative electrode material layer can be referred to as a positive electrode mixture layer, a negative electrode mixture layer, and the like, respectively, because of the form containing a plurality of components.

The positive electrode active material is preferably a material that contributes to storage and release of lithium ions. From this viewpoint, the positive electrode active material is preferably a lithium-containing composite oxide, for example. More specifically, the positive electrode active material is preferably a lithium-transition metal composite oxide containing lithium and at least one transition metal selected from the group consisting of cobalt, nickel, manganese, and iron. That is, the positive electrode material layer of the secondary battery according to the present technology preferably contains such a lithium-transition metal composite oxide as the positive electrode active material. For example, the positive electrode active material may be a lithium cobalt oxide, a lithium nickel oxide, a lithium manganese oxide, a lithium iron phosphate, or one in which these transition metals are partially replaced with another metal. Such a positive electrode active material may be contained as a single kind, but may be contained in combination of two or more kinds.

The binder that can be contained in the positive electrode material layer is not particularly limited, but examples thereof can include at least one selected from the group consisting of polyvinylidene fluoride, a vinylidene fluoride-hexafluoropropylene copolymer, a vinylidene fluoride-tetrafluoroethylene copolymer, polytetrafluoroethylene, and the like. The conductive auxiliary agent that can be contained in the positive electrode material layer is not particularly limited, but examples thereof can include at least one selected from among carbon black such as thermal black, furnace black, channel black, ketjen black, and acetylene black, a carbon fiber such as graphite, a carbon nanotube, and a vapor-grown carbon fiber, metal powders such as nickel, aluminum, and silver, and polyphenylene derivatives, and the like. For example, the binder of the positive electrode material layer may be polyvinylidene fluoride, and the conductive auxiliary agent of the positive electrode material layer may be carbon black.

The negative electrode active material is preferably a material that contributes to storage and release of lithium ions. From this viewpoint, the negative electrode active material is preferably various carbon materials, oxides, lithium alloys, silicon, silicon alloys, and/or tin alloys.

Examples of various carbon materials for the negative electrode active material can include graphite (natural graphite and artificial graphite), mesocarbon microbeads (MCMB), non-graphitizable carbon, graphitizable carbon, surface-decorated graphite, hard carbon, soft carbon, diamond-like carbon, and the like. In particular, graphite is preferable due to high electron conductivity and excellent adhesion to the negative electrode current collector. Examples of the oxide of the negative electrode active material can include at least one selected from the group consisting of a silicon oxide, a tin oxide, an indium oxide, a zinc oxide, a lithium oxide, and the like. The lithium alloy of the negative electrode active material may be metal that can be alloyed with lithium, and may be, for example, a binary, ternary, or higher alloy of lithium with metal such as Al, Si, Pb, Sn, in, Bi, Ag, Ba, Ca, Hg, Pd, Pt, Te, Zn, and La. Such an oxide is preferably amorphous as its structural form. This is because deterioration due to nonuniformity such as grain boundaries and defects is less likely to occur.

The binder that can be contained in the negative electrode material layer is not particularly limited, but examples thereof can include at least one selected from the group consisting of styrene-butadiene rubber, polyacrylic acid, polyvinylidene fluoride, polyimide resins, and polyamideimide resins. For example, the binder contained in the negative electrode material layer may be styrene butadiene rubber. The conductive auxiliary agent that can be contained in the negative electrode material layer is not particularly limited, but examples thereof can include at least one selected from among carbon black such as thermal black, furnace black, channel black, ketjen black, and acetylene black, a carbon fiber such as graphite, a carbon nanotube, and a vapor-grown carbon fiber, metal powders such as copper, nickel, and silver, and polyphenylene derivatives, and the like. Note that the negative electrode material layer may contain a component derived from a thickener component (for example, carboxymethyl cellulose) used at the time of manufacturing the battery.

The positive electrode current collector and the negative electrode current collector used for the positive electrode and the negative electrode are members that contribute to collecting and supplying electrons generated in the active materials due to the battery reaction. Such current collectors may be sheet-like metal members, and may have porous or perforated forms. For example, the current collector may be a metal foil, punching metal, mesh or expanded metal, and the like. The positive electrode current collector used for the positive electrode is preferably made of a metal foil containing at least one selected from the group consisting of aluminum, stainless steel, nickel, and the like, and may be, for example, an aluminum foil. On the other hand, the negative electrode current collector used for the negative electrode is preferably made of a metal foil containing at least one selected from the group consisting of copper, stainless steel, nickel, and the like, and may be, for example, a copper foil.

The separator used for the positive electrode and the negative electrode is a member provided from the viewpoint of preventing a short circuit caused by contact between the positive and negative electrodes and retaining the electrolyte. In other words, it can be said that the separator is a member that allows passage of ions while preventing electronic contact between the positive electrode and the negative electrode. Preferably, the separator is a porous or microporous insulating member and has a film form due to its small thickness. Although it is only an example, a microporous membrane made of polyolefin may be used as the separator. In this respect, the microporous membrane used as the separator may contain, for example, only polyethylene (PE) or only polypropylene (PP) as the polyolefin. Furthermore, the separator may be a laminate formed of “microporous membrane made of PE” and “microporous membrane made of PP”. The surface of the separator may be covered with an inorganic particle coat layer, an adhesive layer, or the like.

The surface of the separator may have adhesiveness. Note that the separator is not particularly limited by its name in the present technology, and may be a solid electrolyte, a gel electrolyte, insulating inorganic particles, or the like having a similar function.

In the secondary battery according to the present technology, the electrode assembly formed of the electrode configuration layers each including the positive electrode, the negative electrode, and the separator is enclosed in the exterior body together with the electrolyte. When the positive electrode and the negative electrode have layers capable of storing and releasing lithium ions, the electrolyte is preferably a “non-aqueous type” electrolyte such as an organic electrolyte and an organic solvent (that is, the electrolyte is preferably a non-aqueous electrolyte). Since metal ions released from the electrodes (positive electrode and negative electrode) exist un the electrolyte, the electrolyte assists the movement of the metal ions in the battery reaction.

The non-aqueous electrolyte is an electrolyte containing a solvent and a solute. As a specific solvent of the non-aqueous electrolyte, one containing at least carbonate is preferable. Such carbonate may be cyclic carbonates and/or chain carbonates. Although not particularly limited, examples of the cyclic carbonates can include at least one selected from the group consisting of a propylene carbonate (PC), ethylene carbonate (EC), butylene carbonate (BC), and vinylene carbonate (VC). Examples of the chain carbonates can include at least one selected from the group consisting of dimethyl carbonate (DMC), diethyl carbonate (DEC), ethylmethyl carbonate (EMC), and dipropyl carbonate (DPC). Although it is only an example, a combination of cyclic carbonates and chain carbonates may be used as the non-aqueous electrolyte, and, for example, a mixture of ethylene carbonate and diethyl carbonate may be used. Further, as a specific solute of the non-aqueous electrolyte, for example, Li salt such as LiPF₆ and/or LiBF₄ is preferably used. Note that the non-aqueous electrolyte may be made of chemical gel.

The exterior body of the secondary battery encloses the electrode assembly in which the electrode configuration layers each including the positive electrode, the negative electrode, and the separator are stacked, but may be in the form of a hard case or the form of a soft case. Specifically, the exterior body may be a hard case type corresponding to a so-called metal can or a soft case type corresponding to a pouch made of a so-called laminate film. As will be described later, the exterior body portion of the secondary battery according to the present technology is preferably the soft case type in view of characteristic items of the present technology.

The secondary battery according to an embodiment of the present technology is characterized by its exterior body. In the secondary battery of the present technology, a sealing edge of the exterior body housing the electrode assembly is formed of a combination of the first exterior body portion and the second exterior body portion, and includes at least a peculiar folded form of metal layers of these exterior body portions and a peculiar adhesive portion related thereto.

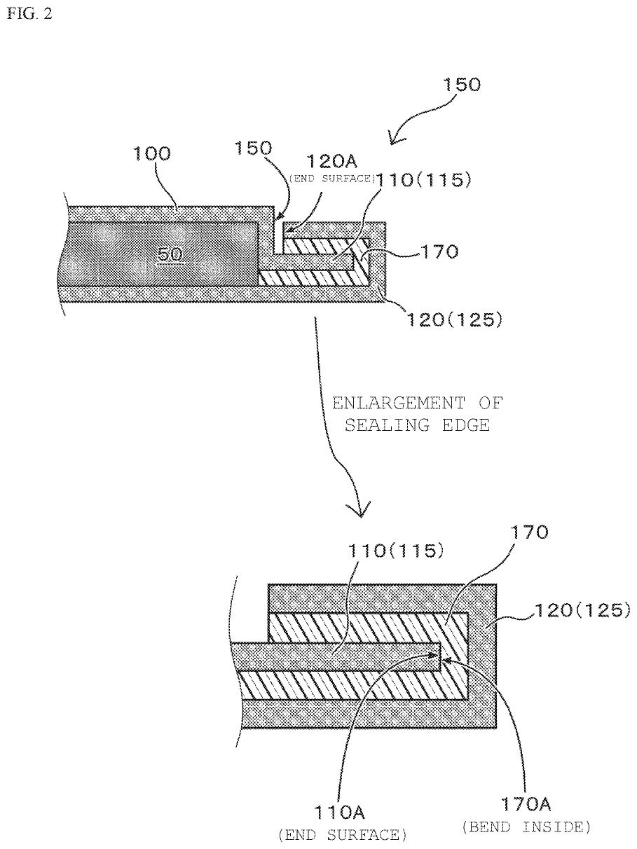

FIG. 2 illustrates a configuration of the sealing edge according to the present technology. A sealing edge 150 of an exterior body 100 housing the electrode assembly 50 is formed of a combination of a first exterior body portion 110 and a second exterior body portion 120. As illustrated in the drawings, the second exterior body portion 120 is folded so as to sandwich the first exterior body portion 110 at the sealing edge 150. That is, one exterior body portion forming the sealing edge is folded so as to wrap the other exterior body portion. In particular, the “one exterior body portion” is folded with a folding point near an end surface of the “other exterior body portion” on the non-folded side.

Preferably, the folding of the second exterior body portion corresponds to one-time folding. That is, it is preferable that the second exterior body portion be folded once while sandwiching the first exterior body portion at the sealing edge 150. Since the folding is performed once, the creation of the sealing edge can be made simpler, and the overall configuration of the sealing edge does not become complicated. In the illustrated aspect, the second exterior body portion 120 corresponding to the “lower exterior body portion” is folded once while wrapping the first exterior body portion 110 corresponding to the “upper exterior body portion” from the lower side (bottom side) to the upper side.

Since such folding is performed, it is preferable that the exterior body portion have flexibility in the secondary battery of the present technology. The “flexibility” facilitates the exterior body to have an enclosed form conforming to a shape of the electrode assembly 50 as illustrated in the drawings. Note that the expression “having flexibility” in the present specification substantially means that the exterior body is not a hard case type corresponding to a so-called metal can but is a soft case type. The exterior body of the soft case type is preferably made of a pouch material, and has, for example, a film-like thin form.

As can be understood from the aspect illustrated in FIG, 2, one of the first exterior body portion 110 and the second exterior body portion 120 respectively corresponding to sub-exterior body portions is positioned so as to entirely cover the upper main surface of the electrode assembly 50, and the other is positioned so as to entirely cover the lower main surface of the electrode assembly 50. In the illustrated aspect, the first exterior body portion 110 is positioned so as to cover the upper main surface of the electrode assembly 50, and the second exterior body portion 120 is positioned so as to cover the lower main surface of the electrode assembly 50, but the opposite may be possible. That is, the sub-exterior body portion positioned so as to cover the upper main surface of the electrode assembly 50 may be folded without folding the sub-exterior body portion positioned so as to cover the lower main surface of the electrode assembly 50.

It is preferable that the first exterior body portion and the second exterior body portion be formed of substantially the same exterior body. That is, the sealing edge of the secondary battery may be formed of the combination of the first exterior body portion and the second exterior body portion, obtained by folding an exterior body in a single form so as to entirety wrap the electrode assembly. However, the present technology is not limited thereto, and the first exterior body portion and the second exterior body portion may be formed of separate exterior bodies. The sealing edge of the secondary battery may be formed by combining two separate exterior body portions so as to respectively cover the upper main surface and the lower main surface of the electrode assembly 50.

In the secondary battery of the present technology, a folded bonding portion is provided at the sealing edge. Specifically, a folded bonding portion 170 having a folded form in a sectional view of the sealing edge is provided in a metal interlayer region between a “metal layer 115 of the first exterior body portion 110” and a “metal layer 125 of the folded second exterior body portion 120”.

The folded bonding portion 170 has a form that is largely curved as a whole while being sandwiched between the metal layers (115 and 125) at the sealing edge 150. As illustrated in the sectional view of FIG. 2, the folded bonding portion 170 preferably has a form that allows folding, and particularly has a folded form while sandwiching the metal layer 115 of the first exterior body portion 110. Accordingly, it can be said that the folded bonding portion according to the present technology has a folded form in which only one of the metal layers is interposed inside.

The folded bonding portion 170 is desirable from the viewpoint of preventing moisture from entering. The adhesive layer forming the sealing edge of the exterior body has permeability with respect to moisture (for example, water components in various forms including water vapor in the air) to some extent, and the inventors of the present application have now found that there is a risk that moisture enters the inside of the battery via such an adhesive layer in the secondary battery. Therefore, the folded bonding portion 170 has a longer moisture permeation path, and has a characteristic that moisture in the surrounding environment is less likely to enter the inside of the exterior body in the secondary battery of the present technology. Since the prevention of the entry of moisture is more suitably achieved in the secondary battery of the present technology, a problem that “the battery performance deteriorates due to the side reaction and the like caused by the moisture that has entered the exterior body” is avoided. This is desirable for applications of the secondary battery, and allows the battery to be used even in more severe environments. In particular, the secondary battery of the present technology has a higher energy density due to the “folding of the second exterior body portion”, which further enhances the possibility of such battery use. To give one example, a battery for wearable applications is often required not only to be small and have a high energy density characteristic but also to withstand the use in hot and humid environments. The secondary battery of the present technology can be suitably used even in applications where such high requirements are required.

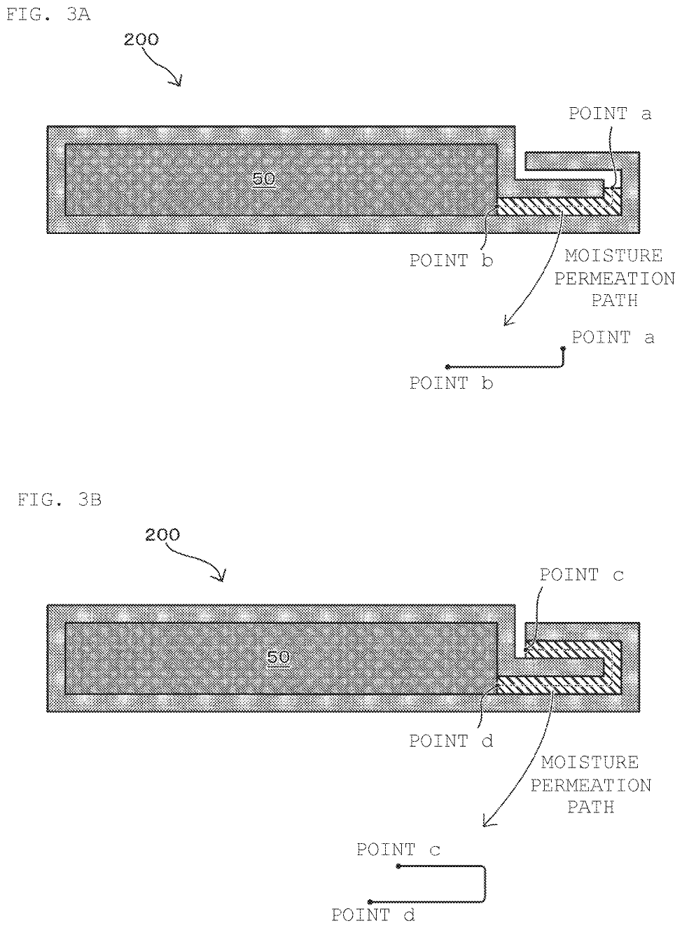

The point of preventing the entry of moisture will be described in detail. FIG. 3(A) illustrates a form of a “bonding portion” of a sealing edge that does not relate to the present technology, and FIG. 3(B) illustrates a form of the “folded bonding portion” of the sealing edge according to the present technology. In FIG. 3(A), which does not relate to the present technology, a moisture permeation path has a distance from point a to point b. The length of the broken line in the drawing indicates the length (effective length) of the moisture permeation path. That is, the moisture in the surrounding environment reaches the inside of the exterior body through a path between the entry through the point a and the exit from the point b. On the other hand, in FIG. 3(B), which relates to the present technology, a moisture permeation path has a distance from point c to point d. Similarly, the length of the broken line in the drawing indicates the length (effective length) of the moisture permeation path, and the moisture in the surrounding environment reaches the inside of the exterior body through a path between the entry through the point c and the exit from the point d. As can be understood by comparing FIGS. 3(A) and 3(B), the “folded bonding portion” according to the present technology has the longer moisture permeation path at the sealing edge. That is, in the “folded bonding portion” according to the present technology, the movement resistance (resistance that moisture can receive) is large in a moisture path until reaching the inside of the exterior body, and thus, the risk that the moisture in the surrounding environment enters the inside of the battery is lowered.

The thickness of the folded bonding portion 170 is not particularly limited, but is preferably as small as possible. That is, it is preferable that the folded bonding portion 170 be as thin as possible. This is because the moisture path (particularly a path cross section orthogonal to the extending direction in the sectional view thereof) can be made smaller as the folded bonding portion 170 is thinner. That is, this is because, if the folded bonding portion 170 is thin, the movement resistance in the moisture path until reaching the inside of the exterior body increases so that it is possible to more reliably reduce the risk that the moisture in the surrounding environment enters the inside of the battery. The thickness of the folded bonding portion 170, appropriate for such an object “thin”, that is, the thickness of a layer itself forming a folded portion at the folded bonding portion 170 is, for example, about 0 μm (not including 0 μm) to 100 μm, and preferably about 0 μm (not including 0 μm) to 20 μm. In such a suitable secondary battery, the thin adhesive layer may have a curved form so as to be largely folded.

The “folded bonding portion” in the present technology is provided with a unique configuration at the sealing edge. In a preferred aspect, the folded bonding portion 170 is in direct contact with both the metal layer 115 of the first exterior body portion and the metal layer 125 of the second exterior body portion throughout the folded form (see FIG. 2). This means that no other layer is interposed between the folded bonding portion and the first exterior body portion, and no other layer is interposed between the folded bonding portion and the second exterior body portion. As the folded bonding portion is directly bonded to both the metal layer of the first exterior body portion and the metal layer of the second exterior body portion in this manner, the airtightness of the sealing edge is improved as a whole.

In a preferred aspect, a protective layer of the exterior body is not provided in the metal interlayer region. That is, the protective layer is not interposed between the folded bonding portion 170 and the first exterior body portion 110 (particularly the metal layer 115 thereof), and no other layer is interposed between the folded bonding portion 170 and the second exterior body portion 120 (particularly the metal layer 125 thereof) (see FIG. 2). Since no protective layer is interposed, the airtightness of the sealing edge can be improved as a whole, and a more compact sealing edge can be obtained. Note that the “protective layer” used herein refers to, in a broad sense, a layer that is conventionally used as a protective layer for an exterior body (particularly a soft-case-type exterior body) of a secondary battery, and means, in a narrow sense, a layer that normally contributes to preventing moisture permeation and damage to a metal layer of an exterior body. To give a simple example, what is used as an adhesive in an exterior body (for example, PP as well as a layer containing modified PP, etc.) does not correspond to the protective layer in the present technology. On the other hand, a layer containing nylon, polyamide, polyester, or the like, can normally correspond to the protective layer in the present technology as will be also described below.

The folded bonding portion and the end surface of the first exterior body are preferably in close contact with each other at the sealing edge. This means that it is preferable that substantially no void or gap be formed between the folded bonding portion and the end surface of the first exterior body in the sectional view of the sealing edge. In the form illustrated in FIG. 2, a bend inside portion 170A of the folded bonding portion 170 and an end surface 110A of the first exterior body portion 110 are in close contact with each other. Such an aspect can improve the airtightness of the sealing edge as a whole. Note that, as can be understood from the description, the “end surface of the first exterior body” in the present specification refers to the outermost edge portion of the first exterior body (the “end surface of the second exterior body” is similar, and refers to the outermost edge portion of the second exterior body).

Further, in a certain preferred aspect, an end surface 120A of the folded second exterior body portion 120 is close to a side surface portion 150 of the exterior body surrounding a side surface of the electrode assembly 50 (see FIG. 2). That is, the second exterior body portion is folded such that the distance from the folding point of the second exterior body portion to the distal end is as long as possible in the sectional view of the sealing edge. In such an aspect, the moisture permeation path in the “folded bonding portion” can be made as long as possible, and the movement resistance of the moisture path until reaching the inside of the exterior body can be further increased.

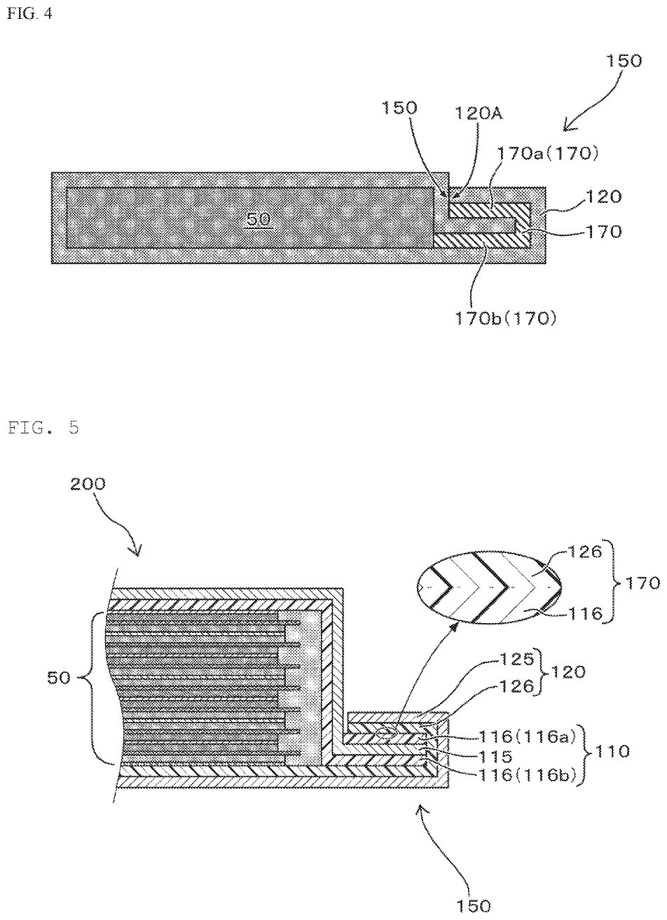

The term “close” in such air aspect means a state where the end surface 120A of the folded second exterior body portion 120 is “adjacent to” or “in contact with” the side surface portion 150 of the exterior body. FIG. 4 illustrates an aspect of the sealing edge 150 in which the end surface 120A of the folded second exterior body portion 120 is in contact with the side surface portion 150 of the exterior body. In the sealing edge of such an aspect, as seen in the sectional view, an upper portion 170a of the “folded bonding portion” positioned on the upper side of the first exterior body portion and a lower portion 170b of the “folded bonding portion” positioned on the lower side of the first exterior body portion may have substantially the same length. In other words, the first exterior body portion 110 may be in a form of being sandwiched between the upper portion 170a and the lower portion 170b of the “folded bonding portion”.

Even if the end surface 120A of the folded second exterior body portion 120 and the side surface portion 150 of the exterior body are separated from each other in the secondary battery of the present technology, it is unnecessary to intentionally a gap therebetween with a sealing material in terms of the entry of moisture. This is because the movement resistance of the moisture in the surrounding environment until reaching the inside of the exterior body is large in the first place since the “folded bonding portion” acts as the long moisture permeation path. Although it is unnecessary to particularly use the sealing material in this manner, a resin material or the like filling the gap between the end surface 120A of the exterior body portion 120 and the side surface portion 150 of the exterior body may be additionally provided, for example, in order to prevent spring back in the folding or the like.

In the secondary battery of the present technology, each of the first exterior body portion and the second exterior body portion preferably has a laminate structure including at least the metal layer and the thermally-fusible resin layer. That is, it is preferable that each of the first exterior body portion and the second exterior body portion have not only the metal layer but also the thermally-fusible resin layer. In the present specification, the “metal layer” is a layer that is substantially impermeable to moisture and/or a gas, and is preferably a metal foil. Although it is only an example, metal of the metal layer may be at least one selected from the group consisting of aluminum, stainless steel, copper, nickel, a nickel-plated steel plate, and the like. On the other hand, the “thermally-fusible resin layer” in the present specification means thermally-fusible resin in a broad sense, and means a resin layer (that is, an adhesive layer) that particularly contributes to melt sealing at the edge of the exterior body in a narrow sense. The specific resin of the thermally-fusible resin layer may be resin containing polyolefin and/or acid-modified polyolefin, and may be, for example, resin containing at least one selected from the group consisting of polypropylene (PP) and polyethylene (PE).

When the first exterior body portion and the second exterior body portion are substantially the same exterior body, the metal layer and the thermally-fusible resin layer of the first exterior body portion are the same as the metal layer and the thermally-fusible resin layer of the second exterior body portion, respectively. That is, when the sealing edge of the secondary battery is formed of the combination of the first exterior body portion and the second exterior body portion obtained by folding the single exterior body so as to wrap the electrode assembly, the metal layer of the first exterior body portion is the same as the metal layer of the second exterior body portion, and the thermally-fusible resin layer of the first exterior body portion is the same as the thermally-fusible resin layer of the second exterior body portion.

In a preferred aspect, the folded bonding portion is formed of a combination of the thermally-fusible resin layer of the first exterior body portion and the thermally-fusible resin layer of the second exterior body portion. As illustrated in FIG. 5, the first exterior body portion 110 is folded while sandwiching the second exterior body portion 120 at the sealing edge 150 of the secondary battery according to the present technology, and thermally-fusible resin layers 116 (116a and 116b) of the first exterior body portion 110 and a thermally-fusible resin layer 126 of the second exterior body portion 120 are laminated on each other to form a laminated bonding portion in a bonding area in the folded form generated in this manner.

When the folded bonding portion is formed of the combination of the thermally-fusible resin layer of the first exterior body portion and the thermally-fusible resin layer of the second exterior body portion, it is preferable that the thermally-fusible resin layers 116 (116a and 116b) of the first exterior body portion 110 and the thermally-fusible resin layer 126 of the second exterior body portion 120 be directly bonded to each other throughout the folded form in the folded bonding portion 170 (see FIG. 5). This means that there is no other layer interposed between the “thermally-fusible resin layer of the first exterior body portion” and the “thermally-fusible resin layer of the second exterior body portion” that form the folded bonding portion. That is, the “thermally-fusible resin layer of the first exterior body portion” and the “thermally-fusible resin layer of the second exterior body portion” that form the folded bonding portion are directly laminated on each other. In this manner, if the thermally-fusible resin layer of the first exterior body portion and the thermally-fusible resin layer of the second exterior body portion are directly bonded to each other throughout the folded form, the airtightness of the sealing edge can be improved throughout the folded form.

When the folded bonding portion is formed of the combination of the thermally-fusible resin layer of the first exterior body portion and the thermally-fusible resin layer of the second exterior body portion, it is preferable that the thermally-fusible resin layers 116 (116a and 116b) of the first exterior body portion 110 and the thermally-fusible resin layer 126 of the second exterior body portion 120 be integrated in the folded bonding portion 170. That is, the folded bonding portion originally includes a portion formed of two layers, but may have a substantially single layer form. This is particularly applied when the first exterior body portion and the second exterior body portion are formed of substantially the same exterior body. That is, when the sealing edge of the secondary battery is formed of the combination of the first exterior body portion and the second exterior body portion, obtained by folding the single exterior body so as to wrap the electrode assembly, the thermally-fusible resin layer of the first exterior body portion and the thermally-fusible resin layer of the second exterior body portion are the same, and are likely to be integrated by being directly bonded to each other.

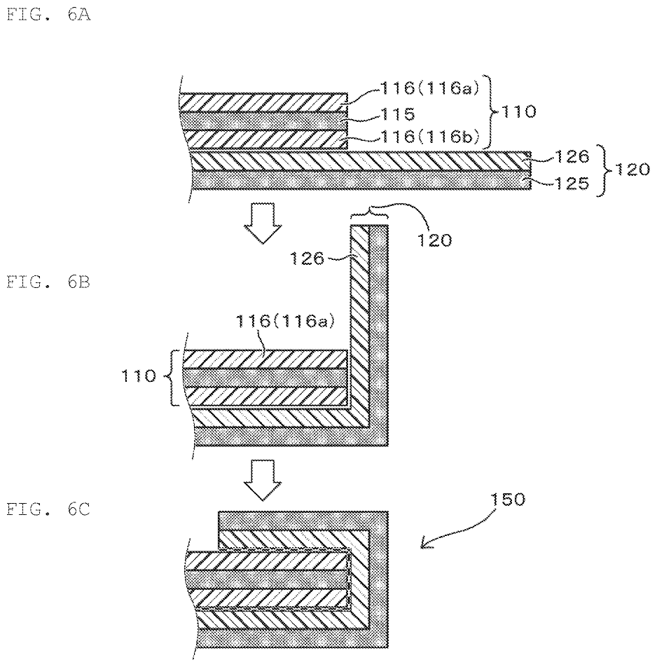

A method of forming the sealing edge as described above will be exemplarily described with reference to FIG. 6. It is preferable that the upper first exterior body portion 110 forming the sealing edge of the exterior body have a configuration in which the thermally-fusible resin layers 116 are provided on both surfaces of the metal layer 115 (that is, it is preferable that the upper thermally-fusible resin layer 116a be provided on the upper surface of the metal layer 115 and the lower thermally-fusible resin layer 116b be provided on the lower surface of the metal layer). On the other hand, it is preferable that the lower second exterior body portion 120 forming the sealing edge of the exterior body have a configuration in which the thermally-fusible resin layer 126 is provided at least on the upper surface of the metal layer 125. In particular, regarding the upper exterior body portion, the thermally-fusible resin layers are provided on both the surfaces of the metal layer, but no protective layer is provided in the portion forming the sealing edge.

First, the second exterior body portion 120 corresponding to the lower side is overlapped so as to protrude outside the first exterior body portion 110 corresponding to the upper side (see FIG. 6(A)). In particular, the second exterior body portion 120 is overlapped on the first exterior body portion 110 such that the thermally-fusible resin layers thereof are aligned with each other. Specifically, the lower thermally-fusible resin layer 116b of the first exterior body portion 110 and the thermally-fusible resin layer 126 of the second exterior body portion 120 are attached to each other.

Next, the protruding lower second exterior body portion 120 is overlapped so as to cover the upper first exterior body portion 110 as illustrated in FIGS. 6(B) and 6(C). That is, the protruding lower second exterior body portion 120 is folded so as to sandwich the upper first exterior body portion 110. At this time, the second exterior body portion 120, which is folded and positioned on the upper side of the first exterior body portion 110, is positioned such that the thermally-fusible resin layer 126 thereof is directly attached to the upper thermally-fusible resin layer 116a of the first exterior body portion 110. After the first exterior body portion 110 and the second exterior body portion 120 are combined in this manner, such a portion is subjected to, for example, hot pressing. The thermally-fusible resin layers are welded (that is, fused) by hot pressing. With such processing, the thermally-fusible resin layers of the second exterior body portion and the folded first exterior body portion are integrated with each other, and as a result, the “folded bonding portion” is provided at the sealing edge.

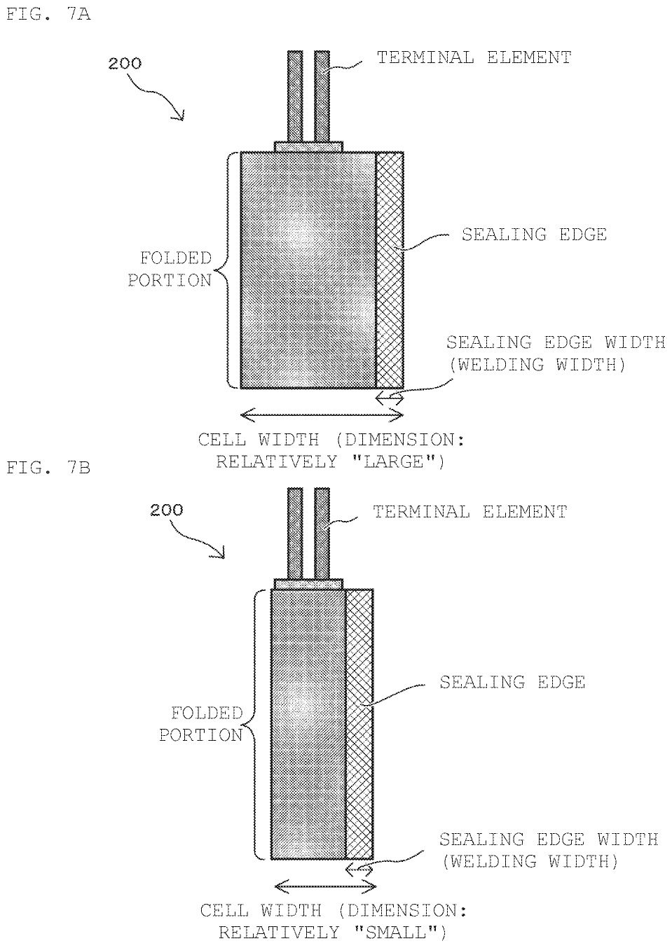

The present technology is particularly suitable for a secondary battery having a smaller “cell width”. FIGS. 7(A) and 7(B) illustrate the relative magnitude of the “cell width”. FIG. 7(A) illustrates a battery with a relatively large cell width dimension, and FIG. 7(B) illustrates a battery with a relatively small cell width dimension. As can be understood from the illustrated form, the “cell width” referred to herein substantially means a battery dimension along a protruding direction of the sealing edge (or a battery dimension in a direction orthogonal to a. protruding direction of a terminal element) in a plan view of the secondary battery.

In the secondary battery illustrated in FIGS. 7(A) and 7(B), a single exterior body encloses an electrode assembly, and is largely folded such that a fold is provided along the protruding direction of the terminal element such as a so-called tab, and a sealing edge is formed of a combination of a first exterior body portion and a second exterior body portion of the exterior body obtained by such folding. Note that the sealing edge corresponds to a portion where thermally-fusible resin layers are welded to each other, and thus, a width of the sealing edge can be referred to as a “welding width”.

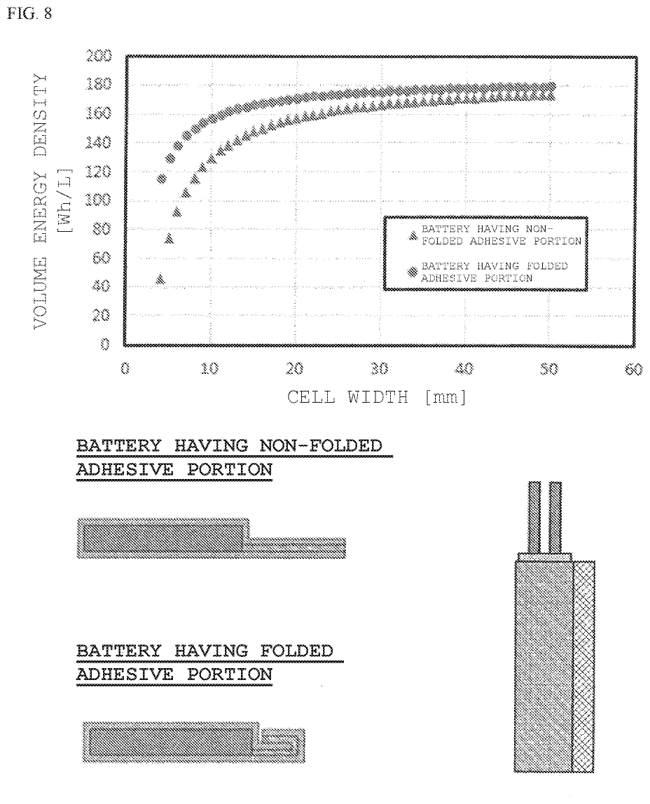

FIG. 8 illustrates a relationship between a cell width and a volume energy density regarding two types of a conventional battery (a battery having a “non-folded bonding portion” and the battery according to the present technology (battery having the “folded bonding portion”) having a moisture permeation path of the same length as the conventional battery. Relevant conditions are given as follows.
Cell size (battery size): thickness dimension 0.25 mm×length dimension*16 mm×width dimension
*(Note) (*“length dimension” and “width dimension” are dimensions orthogonal to each other in plan view)
Welding width (width dimension of sealing edge): battery having “non-folded bonding portion” of 3 mm, battery having “folded bonding portion” of 1.5 mm
Unit weight: 2.0 mAh/cm²

As can be understood from the graph illustrated in FIG. 8, the battery having the “folded bonding portion” maintains the moisture permeation path of the same length as the battery having the “non-folded bonding portion”, and the volume energy density can be unproved. In particular, when the cell width is 30 mm or less (more notably 20 mm or less), a difference in the volume energy densities thereof begins to widen, and the maximum difference is about 2.5 times. That is, under the condition where the cell width is small, the secondary battery of the present technology can have twice or more the energy density as compared with the conventional battery having the moisture permeation path of the same length.

Therefore, in the suitable secondary battery according to the present technology, the cell width dimension is about 40 mm or less, preferably about 30 mm or less, for example, about 25 mm or less or about 20 mm or less. In such a case, for example, the plan view of the secondary battery of the present technology may have an elongated shape as a whole.

The secondary battery of the present technology may be embodied in various forms.

Although the sealing edge is provided at one place in the plan view in the batteries referred to in FIGS. 7 and 8, a form in which the sealing edge is provided at two places may be adopted as illustrated in FIG. 9. In such a case, a single exterior body encloses an electrode assembly, and is largely folded such that a fold is provided along a direction orthogonal to a protruding direction of a terminal element such as a tab, and the sealing edge is formed at two places using a combination of a first exterior body portion and a second exterior body portion of the exterior body obtained by such folding.

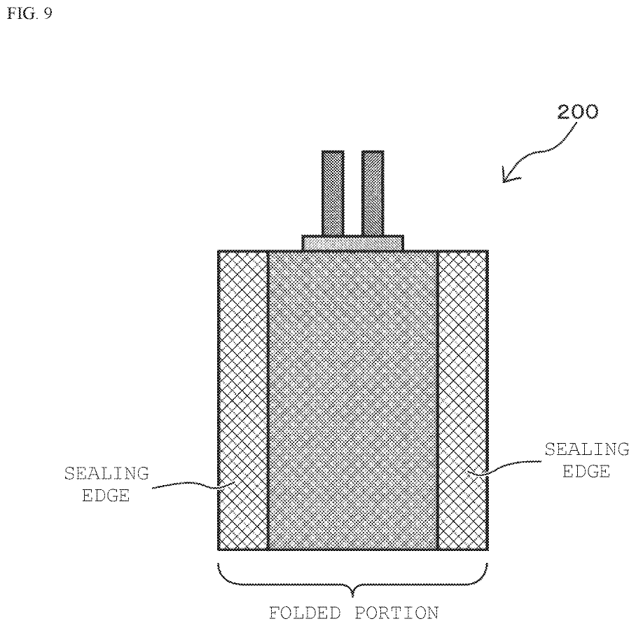

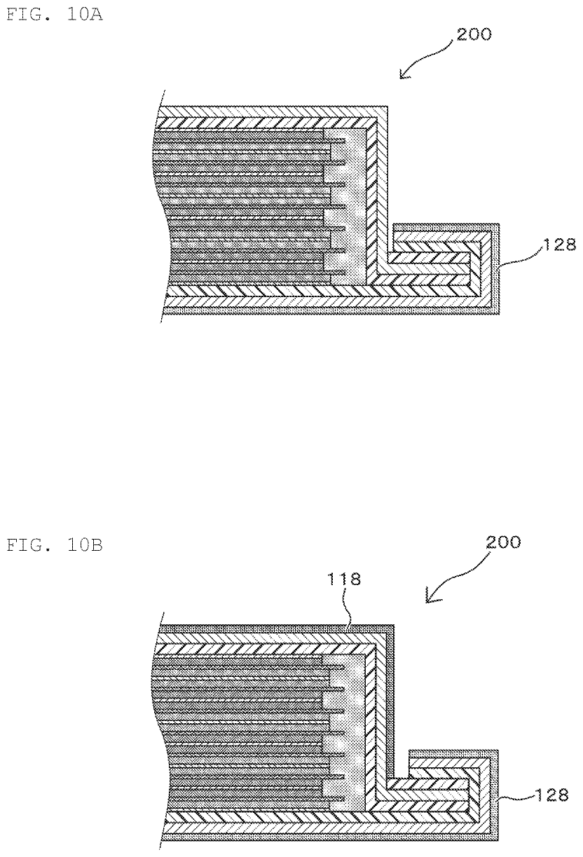

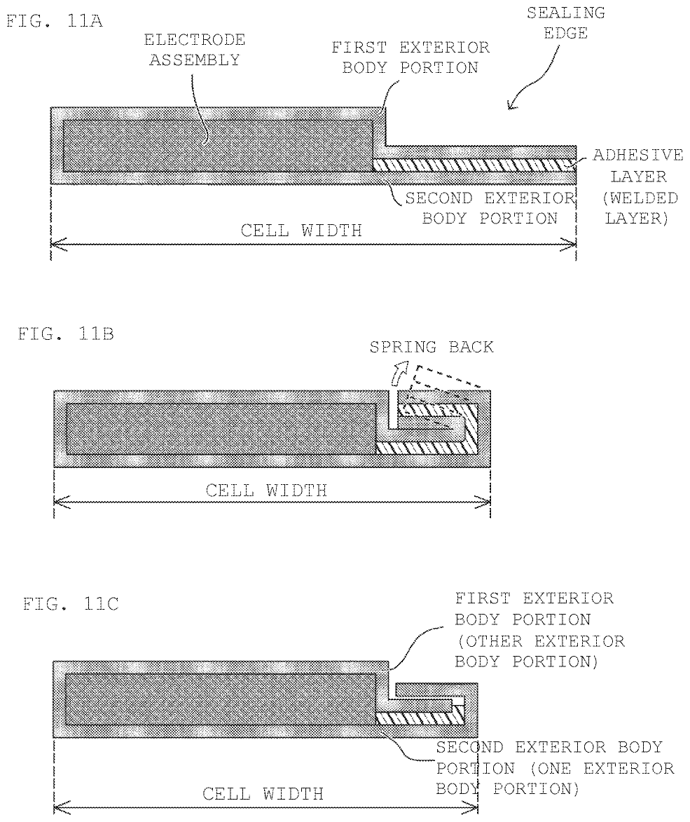

In the present technology, a protective layer may be additionally provided on the exterior body. For example, as illustrated in FIG. 10(A), a protective layer 128 may be provided on the outer surface of the folded second exterior body portion. Further, as illustrated in FIG. 10(B), a protective layer 118 may be also provided on the outer surface (excluding a portion sandwiched by the folded second exterior body portion) of the first exterior body portion. The protective layer preferably contributes to preventing damage to the metal layer caused by permeation and contact of moisture or the like, and is preferably made of heat resistant resin. Examples of such heat resistant resin can include at least one selected from the group consisting of nylon, polyimide, polyester (for example, polyethylene terephthalate), and the like. Note that such an additional protective layer may be attached in advance as an exterior body element, or may be formed later as needed.

Although the embodiment of the present technology has been described as above, the embodiment is merely a typical example. Therefore, those skilled in the art will easily understand that the present technology is not limited to the embodiment and various aspects are conceivable.

For example, the aspect (FIG. 2) in which the sealing material is not required to fill the gap between the folded end surface 120A of the second exterior body portion 120 and the side surface portion 150 of the exterior body has been mentioned in the above description, but the present technology is not necessarily limited to such an aspect. When there is a gap between the end surface 120A of the exterior body portion 120 and the side surface portion 150 of the exterior body, the gap may be additionally filled with a resin material or the like in order to more reliably avoid the risk of the entry of moisture.

Further, the aspect in which the protective layer is additionally provided on each of the first exterior body portion and the second exterior body portion as illustrated in FIG. 10(B) has been mentioned in the above description, the present technology is not necessarily limited to such an aspect. A protective layer may be provided so as to greatly cover the entire cell although it is merely an example. For example, an aspect may be adopted in which a resin layer covers the entire cell (more specifically, the entire first exterior body portion and the second exterior body portion) as a resin mold.

Furthermore, it is mentioned that the electrode assembly is of the flat laminated type (FIG. 1(A)) and the winding type (FIG. 1(B)) in the above description, but the present technology is not necessarily limited thereto. For example, the electrode assembly may have a so-called stack-and-folding type structure in which a positive electrode, a separator, and a negative electrode are laminated on a long film and then folded.

The secondary battery obtained by the manufacturing method of the present technology can be used in various fields where electricity storage is expected. Although it is only an example, the secondary battery can be used in fields of electricity, information, and communication in which mobile devices and the like are used (for example, the fields of mobile devices such as mobile phones, smartphones, laptop computers, digital cameras, activity meters, arm computers, and electronic paper), home and small industrial applications (for example, the fields of electric tools, golf carts, and home, care, and industrial robots), large industrial applications (for example, the fields of forklifts, elevators, and harbor cranes), the fields of transportation systems (for example, the fields of hybrid vehicles, electric cars, buses, trains, electrically assisted bicycles, and electric motorcycles), power system applications (for example, the fields of various types of power generation, road conditioners, smart grids, and general home-installed electricity storage systems), medical applications (the fields of medical devices such as earphone hearing aids), pharmaceutical applications (the fields such as dose management systems), the IoT fields, space and deep sea applications (for example, the fields of space probes and diving research vessels), and the like.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode assembly; and
an exterior body configured to accommodate the electrode assembly,
wherein
the exterior body includes a first exterior body portion, a second exterior body portion and a sealing edge, and the sealing edge is formed of a combination of the first exterior body portion and the second exterior body portion of the exterior body, and
the second exterior body portion is folded back so as to sandwich the first exterior body portion at the sealing edge, and a folded bonding portion in a folded form in a sectional view is provided in a metal interlayer region between a metal layer of the first exterior body portion and a metal layer of the folded second exterior body portion.

2. The secondary battery according to claim 1, wherein a protective layer of the exterior body is not provided in the metal interlayer region.

3. The secondary battery according to claim 1, wherein the folded bonding portion is in direct contact with both the metal layer of the first exterior body portion and the metal layer of the second exterior body portion throughout the folded form.

4. The secondary battery according to claim 1, wherein the second exterior body portion is folded back once.

5. The secondary battery according to claim 1, wherein the folded bonding portion and an end surface of the first exterior body are in direct contact with each other at the sealing edge.

6. The secondary battery according to claim 1, wherein an end surface of the folded second exterior body portion is approximate to a side surface portion of the exterior body surrounding a side surface of the electrode assembly.

7. The secondary battery according to claim 1, wherein the folded bonding portion is formed of a combination of a thermally-fusible resin layer of the first exterior body portion and a thermally-fusible resin layer of the second exterior body portion.

8. The secondary battery according to claim 7, wherein in the folded bonding portion, the thermally-fusible resin layer of the first exterior body portion and the thermally-fusible resin layer of the second exterior body portion are directly joined to each other throughout the folded form.

9. The secondary battery according to claim 7, wherein in the folded bonding portion, the thermally-fusible resin layer of the first exterior body portion and the thermally-fusible resin layer of the second exterior body portion are integrated.

10. The secondary battery according to claim 7, wherein each of the first exterior body portion and the second exterior body portion has a laminate structure including at least the metal layer and the thermally-fusible resin layer.

11. The secondary battery according to claim 1, wherein the exterior body has flexibility.

12. The secondary battery according to claim 1, wherein the electrode assembly includes a positive electrode and a negative electrode.

13. The secondary battery according to claim 1, wherein the secondary battery includes a lithium ion battery.
